(19) United States
(12) Patent Application Publication
(10) Pub. No.: US 2009/0107766 A1
(43) Pub. Date: Apr. 30, 2009

(54) Portable orchard ladder support.

(76) Inventor: Everett J. Smiley, Oakford, IN (US)

Correspondence Address: Frank D. Lachenmaier, 116 N. Main St.,, P.O. Box 1047, Kokomo, IN, 46903-1047, US

(21) Appl. No.: 12/290,148

(22) Filed: Oct. 28, 2008

Related U.S. Application Data
(60) Provisional application No. 61/000,814, filed on Oct. 29, 2007.

(51) Int. Cl. E06C 1/22

(52) U.S. Cl. 182/180.2

(57) ABSTRACT

The present invention relates generally to ladders and more specifically to auxiliary stands or supports for utilization with ladders where it is not possible or desirable to rest the top of the ladder legs against a vertical surface or roof edge guttering for support and the required work height is beyond the reach of a conventional step ladder.

### BACKGROUND

1. Field of Invention

The present invention relates generally to ladders and more specifically to auxiliary stands or supports for utilization with ladders where it is not possible or desirable to rest the top of the ladder legs against a vertical surface or roof edge guttering for support. It is also used where a step ladder is inadequate to reach the desired height such as picking fruit in an orchard, trimming tall hedges or doing other maintenance on trees and shrubs when the branches will not support the weight of a ladder and a worker.

2. Prior Art

The basic principle of free standing ladder supporting structures is well known in the art. An early device was described in U.S. Pat. No. 69,049 to Turner in 1867. Numerous improvements have been attempted since then but none have disclosed a unit that is relatively light weight and easy to move from one place to another over fairly rough and uneven ground and can be easily leveled for safe use.

### SUMMARY OF THE INVENTION

An object of the Portable Orchard Ladder Support is to provide a support system for an extension ladder that allows it to be sustained in a forward leaning mode without the tops of the ladder legs resting against a vertical wall, eaves troughs or tree or shrub branches.

Another object of the Portable Orchard Ladder Support is to provide a support system for an extension ladder that is relatively light in weight and easily repositioned along a hedge for trimming, around a tree for picking fruit or other maintenance treatments, or along a wall for painting or other such activities.

Another object of the Portable Orchard Ladder Support is to provide a support system for an extension ladder that can traverse rough or even ground and can be readily re-leveled at each work site.

Another object of the Portable Orchard Ladder Support is to provide a support system for an extension ladder that is relatively inexpensive to construct.

Another object of the Portable Orchard Ladder Support is to provide a support system for an extension ladder that is easy to disassemble into component parts for storage and shipping.

Another object of the Portable Orchard Ladder Support is to provide a support system for an extension ladder where the support bars are extendable to stabilize taller ladders and the wheels are easily removable or lockable when the system is in position for use.

Another object of the Portable Orchard Ladder Support is to provide a support system where the distal ends of the extendable support bars have rubber insulating boots to eliminate grounding of assembly.

Another object of the Portable Orchard Ladder Support is to provide a support system where an optional adjustable roof interfacing support or tree branch attaching bracket is provided for additional stability when such use is possible.

Still further objects and advantages will become apparent from a consideration of the ensuing description and accompanying drawings. In the description, reference is made to the accompanying drawings which form a part thereof, and in which are shown, by way of illustration, specific embodiments in which the invention may be practiced. These embodiments will be described in sufficient detail to enable those skilled in the art to practice this invention, and be understood that other embodiments may be utilized and that structural changes may be made without departing from the scope of the invention. In the accompanying drawings, like reference characters designate the same or similar parts throughout the several views.

### DRAWINGS

The invention is described with reference to the following drawings:

FIG. 1 is a side view of the Portable Orchard Ladder Support with an extension ladder mounted therein;

FIG. 2 is a front view of the Portable Orchard Ladder Support with an extension ladder mounted therein with retro-pressure bar ladder hold downs;

FIG. 2A is a partial front view showing alternative ladder retention chains replacing retro-pressure bars;

FIG. 3 is a rear view of axle brace assembly;

FIG. 4 is a side view of axle brace assembly;

FIG. 5 is a front view of axle brace assembly;

FIG. 5A is alternative front view of axle brace assembly replacing pivotal ladder support brackets with U-bolts;

FIG. 6 is a perspective view of an optional attachment for use with roof or tree support;

FIG. 7 is a partial side view showing stabilizer assembly with tube connector and extender;

FIG. 7A is a partial side view showing stabilizer assembly with tube connector and extender with castor wheel removed and insulating boot added;

FIG. 8 is a partial perspective rear view showing pivotal ladder support brackets and pivot pins;

FIG. 9 is an enlarged partial side view showing draw bar and attachment; and the ladder shown in FIGS. 1, 2, 2A and 6 in broken lines is shown for illustration only and forms no part of this invention.

### REFERENCE NUMBERS

| | |
|---|---|
| 10 | Portable Orchard ladder |
| | Support |
| 11 | weldment |
| 12 | stabilizer bar |
| 13 | horizontal tube base |
| 14 | front extension tube |
| 15 | forward leaning tube base |
| 16 | rear wheel bar |
| 17 | rearward leaning tube base |
| 18 | ladder support bar |
| 20 | ladder support brace |
| 22 | transport wheel |
| 24 | windlass support bar |
| 26 | windlass assembly |
| 28 | windlass support brace |
| 30 | front cable |
| 31 | axle |
| 32 | axle brace assembly |
| 34 | trailer hitch |
| 36 | draw bar |
| 38 | strap cross-bar chain |
| 40 | castor wheel |
| 42 | bubble level |
| 44 | retro-pressure bar |
| 46 | leveling jack |
| 48 | cable to ladder connector |
| 50 | bar connector rod |
| 52 | turnbuckle |
| 54 | latch pin |
| 56 | ladder |
| 58 | angle iron bar |
| 59 | square hole |
| 60 | grommet seal |
| 62 | extender bar |
| 64 | steel strap cross-bar |
| 66 | steel strap |
| 68 | transport wheel brake assembly |
| 70 | pivotal ladder support bracket |
| | and pivot pin |
| 72 | rear cable |
| 74 | insulating boot |
| 76 | tube connector |
| 78 | pivoting connector clamp |
| 80 | reach bar |
| 82 | roof support feet |
| 84 | pivot plate and lock |
| 86 | tree branch chains |
| 88 | reach bar slide |
| 90 | reach bar lock |
| 92 | pivotal bracket assembly |
| 94 | U-bolt |
| 96 | ladder retention chains |
| 98 | slidable ring |
| 100 | draw bar attachment hole |

### Description

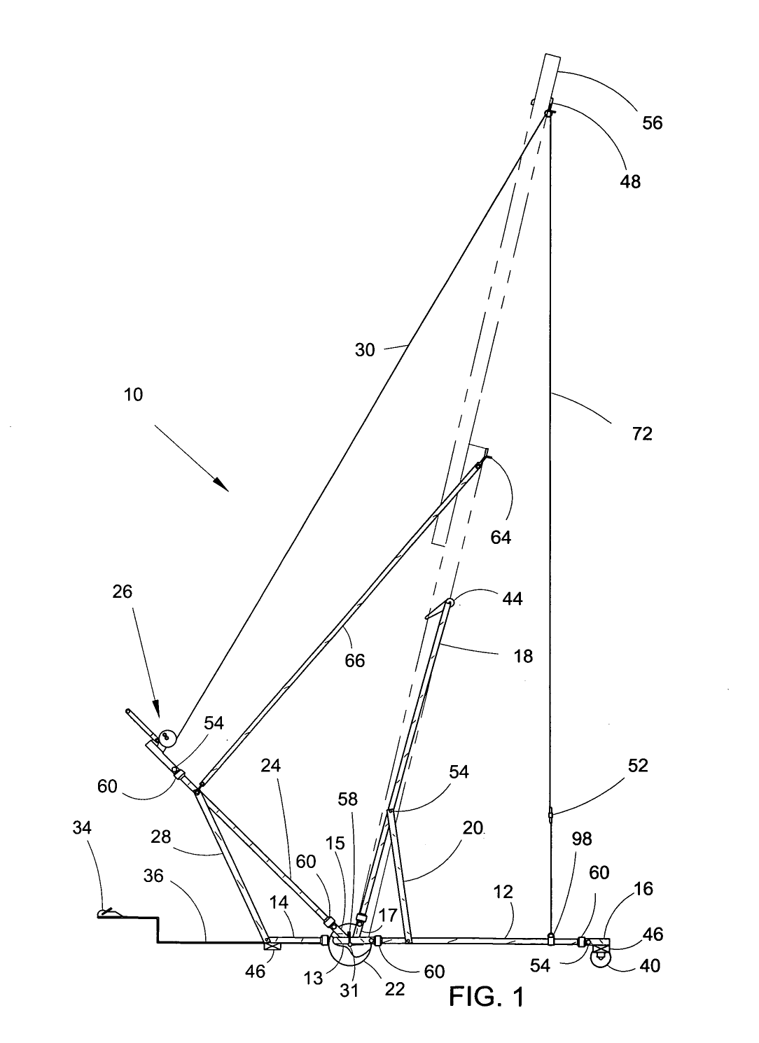

In order that the invention is fully understood it will now be described by way of the following examples in which Portable Orchard Ladder Support 10 is shown in FIGS. 1-9 with representative ladder 56 shown in phantom lines for illustration purposes only. Ladder 56 is not a part of this invention. Portable Orchard Ladder Support 10 is designed for ease of assembly and disassembly for minimum required storage space.

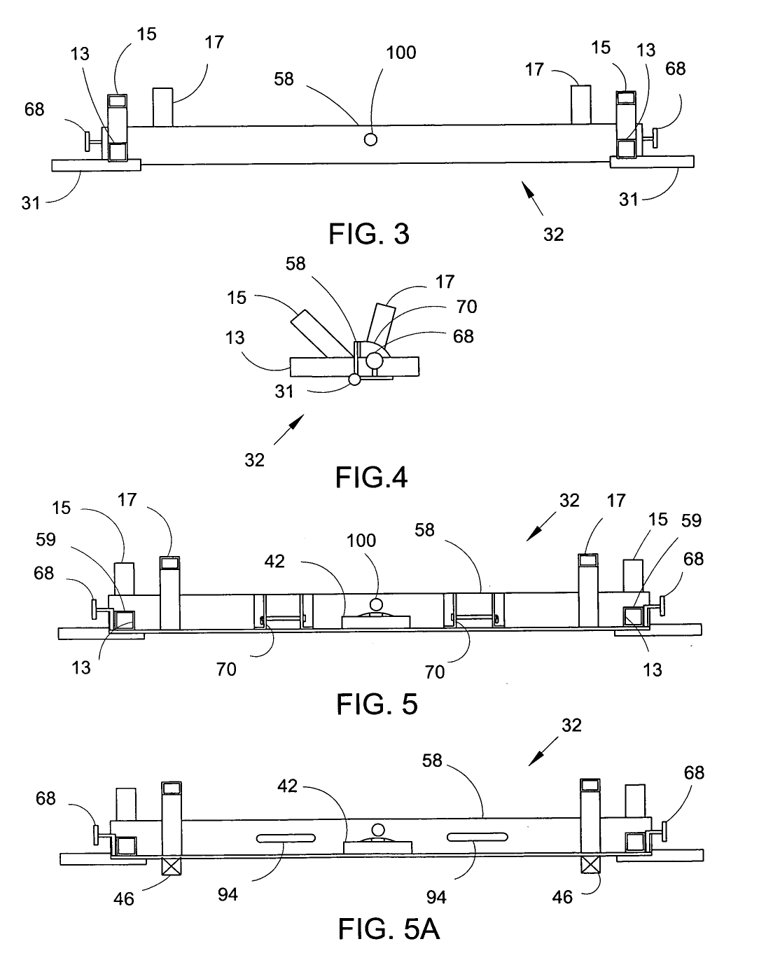

Turning to FIGS. 3, 4 and 5 axle brace assembly 32 is disclosed with angle iron bar 58 preferably approximately 42 inches in width made from a 3 inch by 3 inch angle of ¼ inch cold rolled steel. Affixed to each end of angle iron brace 58 are axles 31 for transport wheels 22. There are two 1½ In. square holes 59 though the upstanding side of the angle, the bottom edge of which aligns with the top surface of the bottom side of angle iron brace 58. Square holes 59 are toward each end of angle iron brace 58.

Two weldments 11 are comprised of approximately 12 inch long by 1½ inch square horizontal tube bases 13 with approximately 6 inch long by 1½ inch square forward leaning tube bases 15 attached to the top surface of horizontal tube base 13 and leaning forward at approximately 45 degrees from the vertical. Forward leaning tube bases 15 are approximately centered on the 12 inch length of horizontal tube base 13. Back ends of horizontal tubes 13 are slipped through square holes 59 from the front until they seat the back edge of forward leaning tube base 15 against the front edge of upstanding side of angle iron bar 58 and weldments 11 are then welded to angle iron bar 58. Affixed to the top surface of the horizontal side of angle iron bar 58 just inside weldments 11 are two 1½ inch square rearward leaning tube bases 17 approximately 6 inches long leaning rearward at an angle of approximately 15 degrees. Also optional leveling jacks 46 can be placed under the ends of angle iron bar 58.

There are friction transport wheel brake assemblies 68 mounted at either end adjacent to axles 31. Axle brace assembly 32 also includes bubble level 42 mounted in the center of angle iron bar 58 on the top of its horizontal side. Also mounted to the back surfaces of angle iron bar 58 are two pivotal ladder support brackets and pivot pins 70 that replace the standard pivoting feet on standard extension ladders. These are shown in FIG. 5 and in FIG. 8 where a pivot pin is run through the normal mounting holes for standard ladder pivoting feet with various ladder angle set points. Alternatively conventional ladder feet could be left on a conventional extension ladder 56 and the ladder legs secured to angle iron bar 58 with standard U-bolts 94 and leveling jacks 46 added under each end of angle iron bar 58 as shown in FIG. 5A.

Transport wheels 22 are mounted on axles 31 that extend out from axle brace assembly 32. Approximately 14 inch long by 1¼ inch square front extension tubes 14 are slipped into the front of 1½ inch square horizontal tube bases 13 with grommets seals 60 covering their sliding junctions and pinned in place with latch pins 54. Approximately 5 foot long by 1¼ inch square tubing windlass support bars 24 are slipped into top opening of forward leaning tube base 15 with grommets seals 60 covering their sliding junctions and pinned in place with latch pins 54. Windlass support brace 28 is an approximately 36 inch long by 1½ in square tube with the rearward face of the tube removed at each end by a sufficient length to allow brace 28 at its top end to slip over the sides of windlass support bar 24 and at its bottom end to slip over the distal end of front extension tube 14 with clearance holes for latch pins 54 used to secure the connections. Leveling jacks 46 are mounted on the under side of the distal end of front extension tubes 14 and windlass assemblies 26 slip over the distal ends of windlass support bars 24 again with the joints protected with grommet seals 60 and secured with latch pins 54.

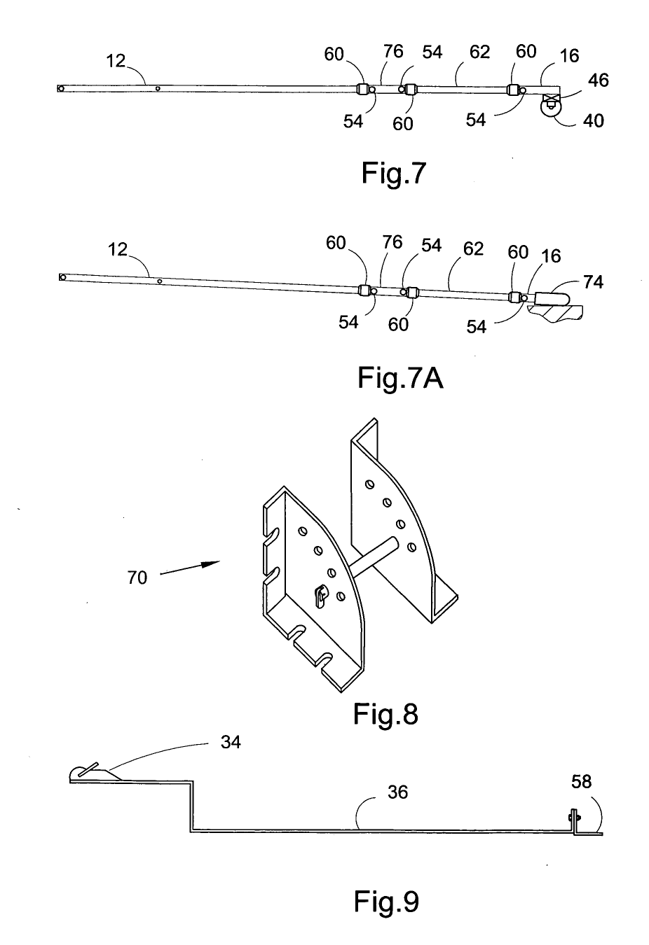

1¼ inch square tube stabilizer bars 12, approximately 5 feet long, are slid into the back end of horizontal tube bases 13, with the joints between stabilizer bars 12 and horizontal tube base 13 sealed with grommet seals 60 and secured with latch pins 54. 1½ inch square tube rear wheel bars 16 approximately 8 inches long, slip over the back ends of stabilizer bars 12 and the joints between them and rear wheel bars 16 are sealed with grommet seals 60 and secured with latch pins 54. Leveling jacks 46 are mounted on the under side of the distal end of rear wheel bars 16. For taller ladders, FIG. 7 shows an optional extension placed between the end of stabilizer bar 12 and rear wheel bar 16 by adding 1½ inch square tube connector 76, approximately 8 inches long, to end of stabilizer bar 12 and inserting 1¼ inch square tube extender bar 62, approximately 2 feet long, into rear of tube connector 76 and then sliding rear wheel bar 16 over the rear end of extender bar 62. Tube connector 76's joint with stabilizer bar 12 is sealed with grommets 60 and pinned in place with latch pins 54. Rear wheel bars 16 have castor wheels 40 suspended from their rear end. Alternatively, as shown in FIG. 7A, rear wheel bars 16 can have insulating boots 74 stretched over their rear ends to provide insulation for Portable Orchard ladder support 10 for doing elevated electrical work where grounding might become an issue.

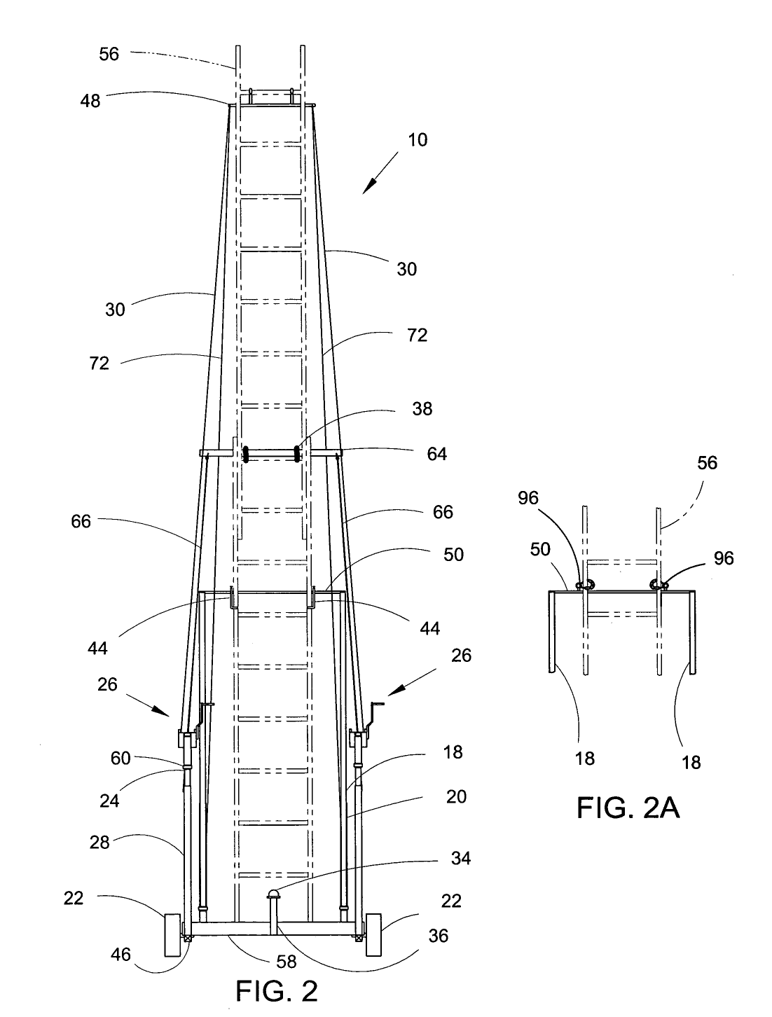

1¼ inch square tubing ladder support bars 18, approximately 7 feet long, are slid into rearward leaning tube bases 17 with the joint between support bars 18 and rearward leaning tube bases 17 sealed with grommets 60 and pinned with latch pins 54. At the top of support bars 18 are pivotally mounted retro-pressure bars 44 that clamp the ladder securely against ladder support bars 18 and can be held in place with a thumb screw device as shown in FIGS. 1 and 2. Alternatively, small ladder retention chains 96 are used with hooks to secure ladder 56 to distal ends of support bars 18 as shown in FIG. 2A.

Ladder support braces 20 are approximately 30 inch long by 1½ in square tubes with the forward face of the tube removed at each end by a sufficient length to allow support braces 20 to slip over the sides of ladder support bars 18 at its top end and to slip over stabilizer bar 12 at the bottom end with clearance holes for latch pins 54 used to secure the connections. Ladder support bars 18 are connected with bar connector 50 at their top ends.

steel straps 66 are approximately 12 ft long and 1 inch wide and ⅛ inch thick and are connected to windlass support bars 24 at the junction of windlass support braces 28 and windlass support bars 24 at the bottom end and connect to steel strap cross-bar 64 which is connected to top step of base ladder at the top end by strap cross bar chains 38 on each end. Steel strap cross-bar 64 is approximately a 36 inch wide 1½ inch by 1½ inch angle iron.

Each windlass assembly 26 has an approximately 28 foot long front cable 30 wound around its core which extends from windlass assembly 26 to cable to ladder connector 48. Cable to ladder connector 48 is comprised of two hooks that hook over the front and top of a step of a ladder in use well above ladder support bars 18. The hooks extend downward to a cross-bar with eyes for snaps at each end for front cables 30 to attach to. Said cross-bar goes behind the ladder such that when the windlasses are drawn tight the ladder is supported equally on each side by front cables 30. A second set of rear cables 72 drop from these connectors and are attached to the stabilizer bars 12 at slidable ring 98 as shown in FIG. 1. Rear cables 72 have turnbuckle 52 in the center to adjust the tension to a sufficient level as to reduce the bounce in Portable Orchard ladder Support 10 while it is supporting ladder 56 that is being climbed by a workman.

Draw bar 36 is shown in FIG. 9 as a stepped steel bar approximately 3 inches wide and ⅛ inch thick that has a proximal end bent up at 90 degrees with a bolt hole centered in bent up proximal end that aligns with draw bar attachment hole 100 in the center of the upstanding side of angle iron bar 58 as shown in FIGS. 3 and 5 for connection to or disconnect from axle brace assembly 32. Attached to the distal end of draw bar 36 with a step to match the pulling device hitch height, is a conventional trailer hitch 34 as shown in FIG. 9.

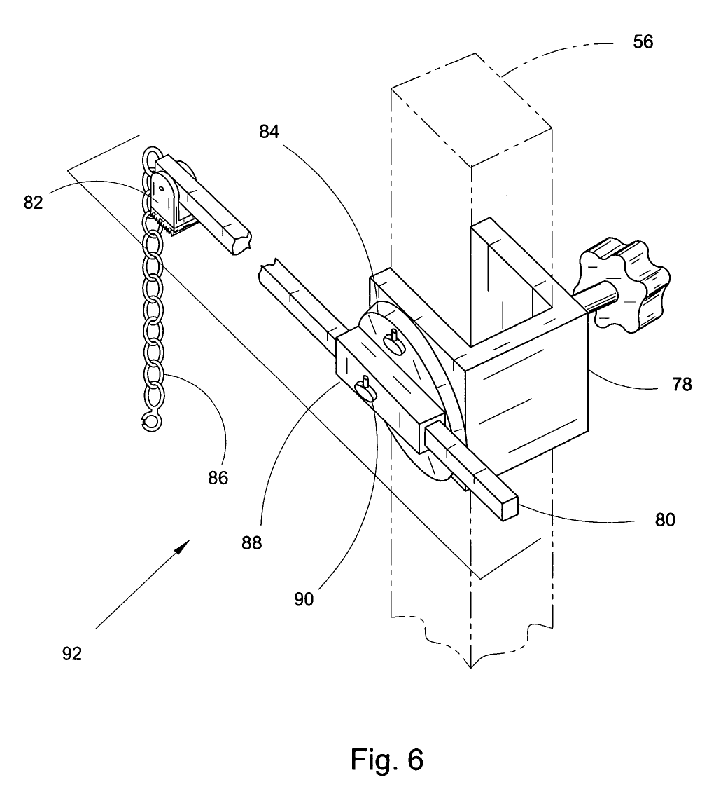

An optional attachment is shown in FIG. 6 where pivotal bracket assembly 92 is used to support each leg of ladder 56 where either a roof or a large tree branch is available to provide additional stability. Pivotal bracket assembly 92 is comprised of pivoting connector clamp 78 attachable to the top of each leg of ladder 56. Connector clamps 78 are U-shaped brackets with clamping means that tighten against the ladder legs and with pivot plates 84 pivotally mounted to the outside of connector clamps 78. Pivot plate 84 has a 1¼ inch square tube reach bar slide 88 approximately 6 inches long attached to its outer surface. Reach bars 80 are 1 inch square bars, approximately 3 feet long and are slipped into reach bar slides 88 and secured in place with reach bar locks 90. At the distal ends of reach bars 80 are pivotally attached skid resistant roof support feet 82 that automatically align themselves to the pitch of whatever roof they are put in contact with. Pivot plate 84 can be rotated to the appropriate angle such that reach bars 80 are parallel to the pitch of roof mount, if so desired. Optionally tree branch chains 86 can be used to secure the distal ends of reach bars 80 to a large branch on a tree.

Although this invention has been described by detailing a preferred embodiment with several optional attachments it is not intended to be limited to this set of materials and dimensions. Rather, the scope of this invention is defined by the following claims.

What is claimed is:

1. A portable orchard ladder support system for a ladder that allows it to be moved over rough and uneven ground and leveled on various work sites without lowering the ladder where there is no vertical support available for the upper ends of the ladders side rails comprising:
an axle brace assembly formed with an upward and rearward opening angle iron bar with an upstanding side with front and back surfaces and a horizontal side with top and bottom surfaces, square holes through said upstanding side with bottom side of said square hole on same plane as said top surface of said horizontal side of said angle iron bar;
a bubble level attached to approximate center of the top surface of said horizontal side of said angle iron bar;
axles for transport wheels attached to each end of said angle iron bar with transport wheel brake assemblies mounted adjacent to said axles and transport wheels mounted on said axles;
weldments comprised of forward leaning tube bases and horizontal tube bases made from square tubing of a size that will slip fit through said square hole in said angle iron bar with a top surface where said forward leaning tube bases are welded to the approximate center of said top surface of said horizontal tube bases at an angle of approximately 45 degrees from the vertical, where said weldments are slipped through said square holes in said angle iron bar from the front until the back bottom edge of said forward leaning tube base contacts said front surface of said upstanding side of said angle iron bar and welded in place;
rearward leaning tube bases welded to said top side of said horizontal side of said angle iron bar adjacent to the inside wall of said weldments leaning rearward at an angle of approximately 15 degrees;
pivotal ladder support brackets fastened to said back surface of upstanding side of said angle iron bar and said top surface of said angle iron bar in an adjustable fashion as to fit various extension ladder widths and leg sizes and attach to ladder legs using the pivot holes in conventional extension ladders with conventional pivoting feet;
windlass support bars with distal and proximal ends made from square tubing where said proximal end slip fits into said forward leaning tube bases, with a grommet seal to cover the joint and secured with latch pins;
windlass assemblies built on square tubing that slip fits over distal end of said windlass support bars where said joint are sealed with said grommets and secured with said latch pins where said windlass has approximately 28 feet of front cable wound around its rotating center with a conventional hand crank and a ratcheting lock system;
front extension tubes that slip fit into front opening of said horizontal tube bases where said joints are protected by said grommets and secured with said latch pins and have leveling jacks depending from the bottom of the distal ends of said front extension tubes;
windlass support braces made from square tubing with front, rear and side surfaces where said tubing is large enough to slip fit over front extension tubes and windlass support bars when the rear surfaces are open at each end with through holes in said side surfaces that match to the latch pin holes in said distal end of said front extension tubes and the intermediate latch pin location on said windlass support bar and are secured in place with said latch pins;
stabilizer bars made from square tubing that slip fits into the rear opening of horizontal tube base where the joint between horizontal tube base and stabilizer bar is protected with said grommet seal and secured with said latch pin;
rear wheel bars made from square tubing that slip fits over rear end of said stabilizer bar where joint is protected with said grommet seals and secured with said latch pins and has castor wheels depending from the under side of said rear wheel bars and leveling jacks depending from rear ends of said rear wheel bars;
ladder support bars made from square tubing that slips into rearward leaning tube bases and the joint between said ladder support bars and rearward leaning tube bases are protected by said grommet seals and secured by said latch pins;
ladder support braces made from square tubing with side, front and back surfaces where said front surface is opened at each end and back surface is open at bottom a sufficient distance as to clear sliding over stabilizer bars at the bottom end an over ladder support bar at an intermediate level where clearance holes for latch pins are provided in both sides walls of the opened ends that align with the latch pin holes in said stabilizer bar and ladder support bar and the joints are secured with said latch pins;
bar connector rod attached between top ends of ladder support bars with a retro-pressure bar on each end with a pivotal arm that traps the leg of a ladder against the ladder support bar and includes a thumb twist hold down once the ladder is in place;
steel strap cross-bar chained to the top step of the bottom section of a conventional extension ladder;
steel straps connected from either side of said steel strap cross-bar at the top end and connected to said windlass support bars at the bottom ends at the approximate height of said windlass support braces interface with windlass support bars;
cable to ladder connector constructed with rods formed with hooks at the top ends to hook over the top step from the back side of the top section of a conventional extension ladder where the rods are connected at the bottom with a cross-bar with rings attached at both ends and said front cable from said windlass assemblies are snapped into said rings and said front cable let out as extension ladder raised and pulled tight and latched when ladder at desired operating height, and rear cable is also snapped into said rings and dropped straight down to a tightening turnbuckle and then down to a slidable ring attached to said stabilizer bar; and
draw bar attached to center of upstanding side of said angle iron bar with step up to towing vehicle height with standard trailer hitch mounted thereon.

2. Same as claim 1 except pivotal ladder support brackets are replaced with U-bolts that trap the bottom of said ladder leg against said rear surface of said upstanding side of said angle iron bar.

3. Same as claim 1 except that it utilizes chains instead of retro-pressure arms to hold said ladder against said ladder support bars.

4. Same as claim 1 further comprising additional leveling jacks placed under each end of said angle iron bar.

5. Same as claim 1 further comprising:
pivotal bracket assemblies that are comprised of
pivoting connector clamps that are clamped onto the top of each ladder leg;
a rotatable pivot plate and lock mounted to the outside of said pivoting connector clamps;
reach bar slides formed by attaching square tubes to outside of said rotatable pivot plates;
reach bars formed from square tubes and are slipped into said reach bar slides, adjusting their extension to allow the proper side wall clearance whereby the roof edge or guttering is not damaged by contact with said ladder legs;
reach bar locks adjusted to secure said location; and
roof support feet pivotally connected to the distal ends of said reach bars whereby additional stability can be achieved by placing said roof mounting feet onto a roof angled to the same pitch as the roof.

6. Same as claim 5 further comprising tree branch attaching chains extending from the distal ends of said reach bars.

7. Same as claim 1 further comprising extensions to said stabilizer bars to increase the stability for taller ladder extensions or heavier loads comprising a tube connector made from a square tube that slips over the rear end of said stabilizer bar and an extender bar made from a square tube that slips into the rear of said tube connector at the front end and slips into said rear wheel bar at the back end, again with the joints protected by said grommet seals and the connections secured with said latch pins.

8. Same as claim 1 further comprising insulating boots slipped over the distal ends of said support bars, insulating said ladder support system from ground for safely working with or around electricity.
